(19) United States
(12) Patent Application Publication
(10) Pub. No.: US 2026/0302003 A1
(43) Pub. Date: Oct. 1, 2026

(54) ELECTRICAL FEEDTHROUGH FOR ELECTRICAL COMPONENTS IN ELECTRICAL REFRIGERANT COMPRESSORS

(71) Applicant: Hanon Systems, Daejeon (KR)

(72) Inventors: Senol Gecgel, Köln (DE); Ayhan Ayar, Köln (DE); Bernd Guntermann, Lennestadt (DE)

(21) Appl. No.: 19/560,568

(22) Filed: Mar. 9, 2026

(30) Foreign Application Priority Data
Mar. 27, 2025 (DE) 102025111857.4
Nov. 20, 2025 (DE) 102025148188.1

(51) Int. Cl. H01B 17/58; B60H 1/32; B60R 16/02

(52) U.S. Cl. CPC H01B 17/583; B60H 1/3226; B60R 16/0222

(57) ABSTRACT

An electrical feedthrough for encapsulated electrical components in electrical refrigerant compressors, in particular electrical R744 refrigerant compressors of air-conditioning systems, specifically vehicle air-conditioning systems, having a conical sleeve and an electrically conductive metal pin, which are pressed into a corresponding conical housing opening in a metal housing, wherein the electrically conductive metal pin has a conical portion, which corresponds with an inner cone angle of the conical sleeve, wherein the conical sleeve is formed from a crosslinked thermosetting plastic and has at least one inner circumferential, annular elevation and at least one outer circumferential, annular elevation, which form an encircling, sealing press fit in the conical housing opening, wherein no additional joining or connecting agent is introduced between the inner wall of the conical housing opening and the conical sleeve or between contacting surfaces of the electrically conductive metal pin and the conical sleeve.

### CROSS REFERENCE TO RELATED PATENT APPLICATIONS

This patent application claims the benefit of and priority to German Pat. Appl. No. 10 2025 148 188.1 filed on Nov. 20, 2025, and German Pat. Appl. No. 10 2025 111 857.4 filed on Mar. 27, 2025, the entire contents of each of which are incorporated herein by reference.

### TECHNICAL FIELD

The invention relates to electrical feedthroughs for encapsulated electrical components in electrical refrigerant compressors, in particular in electrical R744 refrigerant compressors of air-conditioning systems, specifically vehicle air-conditioning systems. The invention also relates to a method for installing the electrical feedthroughs with which the electrical side, i.e., the power electronics and the inverter, is separated permanently and in a media-tight manner from the pressurised region of the compressor, and at the same time reliable transmission of electricity into the motor housing takes place.

### BACKGROUND

Electrically operated refrigerant compressors are a central structural element of modern air-conditioning and heat pump systems, in particular in the field of vehicle technology. These compressors are increasingly being operated with the natural refrigerant R744 (CO₂), since this has a particularly low global warming potential and at the same time offers a high level of energy efficiency. However, the use of the refrigerant R744 entails considerable design challenges. Firstly, the refrigerant is under very high pressures during operation, which are considerably above the pressure level of traditional refrigerants such as R134a or R1234yf. Secondly, the combination with compressor oil can attack polymer-based seals. In addition, a permanent and reliable partition between the pressurised region and the region exposed to atmospheric pressure must be ensured in electrical compressors. Failure of this partition would immediately result in a loss of refrigerant, which would cause the compressor to fail.

To provide electrical contacting, so-called E-pins are used, which are fed through the metallic motor housing as feedthrough elements. These E-pins provide both the function of the electricity supply into the electric motor arranged in the interior and the sealing between the electrical and mechanical sides of the system. In practice, conical feedthroughs are used for this, in which case a metallic metal pin with a conical portion together with a conical sleeve consisting of a heat-curing plastic is pressed into a corresponding conical bore in the compressor housing. The conical geometry ensures force-fitting self-locking and a high contact pressure. However, since the refrigerant R744 itself can diffuse through microscopic gaps or pores, the simple press fit is not sufficient to ensure secure sealing. For this reason, the cone faces are wetted with an epoxy resin adhesive before joining. The pressing in of the conical sleeve causes the adhesive to be distributed in the cone gap. This is followed by curing in a furnace, typically at a temperature of approximately 160° C. for a duration of at least 45 minutes.

However, this method is associated with disadvantages. It has proven time-and cost-intensive, since the sealing function depends on many process parameters. These include the exact volume of the applied adhesive, its distribution and positioning on the cone faces, the pressing force applied during the joining process, and the insertion path of the E-pin. Also included are the parameters of the temperature management during curing. Even slight deviations can mean that there is too little adhesive present or that undesirable air bubbles form. Both increase the risk of leaks during operation under the high operating pressures.

This situation is particularly problematic for use in R744 refrigerant compressors. Owing to the high pressure level, even microscopically small leaks are enough to result in an insidious or even rapid loss of media. As soon as the refrigerant gets into the electrical region of the inverter, there is a risk of electrical short circuits with serious damage. At the same time, the electrical feedthroughs are exposed to high thermal loads, since the ambient heat in the engine compartment of a vehicle has an effect on the components. This places additional demands on the durability of the adhesives and plastics used. The known method of the conical feedthrough with epoxy adhesive and furnace curing therefore proves particularly sensitive and time-and cost-intensive for the series production of electrical R744 refrigerant compressors and exhibits only low robustness to process and production variations.

### SUMMARY

The object of the invention is therefore to propose a concept for an electrical feedthrough for encapsulated electrical components in electrical refrigerant compressors, in particular in electrical R744 refrigerant compressors of air-conditioning systems, specifically vehicle air-conditioning systems, which is resistant to refrigerant and compressor oil and allows simple installation. It is also an object of the invention to propose a method for installing an electrical feedthrough.

The object is achieved by the subject matter having the features shown and described herein.

An electrical feedthrough for encapsulated electrical components in electrical refrigerant compressors, in particular in electrical R744 refrigerant compressors of air-conditioning systems, specifically vehicle air-conditioning systems, is proposed. According to the invention, the electrical feedthrough has a conical sleeve and an electrically conductive metal pin, which are together pressed into a corresponding conical housing opening in a metal housing. The electrically conductive metal pin has a conical portion which corresponds with an inner cone angle of the conical sleeve. The conical sleeve is formed from a crosslinked thermosetting plastic and has at least one inner circumferential, annular elevation and at least one outer circumferential, annular elevation. The at least one inner circumferential, annular elevation and the at least one outer circumferential, annular elevation form an encircling, sealing press fit in the housing opening without an additional joining or connecting agent being necessary. As a result, no additional joining or connecting agent is introduced between the inner wall of the conical housing opening and the conical sleeve or between contacting surfaces of the electrically conductive metal pin and the conical sleeve.

It has been found that a leak tightness which meets the requirements is achieved solely by axially pressing the conical sleeve with the electrically conductive metal pin in the conical housing opening. This advantage is attributable to the material of the conical sleeve in conjunction with the inner circumferential and outer circumferential annular elevations formed on the conical sleeve. The conical sleeve formed from duromer thus has a greater hardness than the electrically conductive metal pin and the metal housing in which the housing opening is formed. As a result, the at least one inner circumferential, annular elevation and the at least one outer circumferential, annular elevation cause local deformations on the respectively opposing metal surfaces, i.e., in the housing opening and on the electrically conductive metal pin, during pressing, which deformations, together with the self-locking effect of the conical contact faces, form a particularly leakproof connection. Since the invention does not require adhesives and additional heat treatment steps, costs can be saved and the installation can be simplified.

The crosslinked thermosetting plastic can be a rock-meal-filled, phenol-resin-based resin, in particular a phenol formaldehyde resin, which is cured by thermal crosslinking.

According to one embodiment, the electrically conductive metal pin can have at least one annular elevation along the conical portion. In contrast to the conical sleeve, the at least one annular elevation of the electrically conductive metal pin is deformable on the conical sleeve surface, as a result of which the leak tightness in the pressed state is increased further.

The conical contact faces of the conical sleeve result in play-free centring and a self-locking connection of the components. According to an advantageous embodiment, the inner cone angle of the conical sleeve can be steeper than an outer cone angle of the conical sleeve. For example, the conical sleeve can have a cone with a ratio of 1:10 on the outside, while an inner cone has a ratio of 1:7.5. The flatter outer cone with a ratio of 1:10 means that the conical sleeve is first moved relative to the housing opening and fixed there securely on axial pressure. Only then does the steeper inner cone with a ratio 1:7.5 take effect so that the electrically conductive metal pin is displaced relative to the already fixed conical sleeve. In this way, tilting of the components is avoided, the components centre themselves, and a defined preloading is produced, which improves the mechanical stability. Overall, the installation is made easier, and the risk of incorrect positioning is reduced thereby.

It can be provided for the at least one inner circumferential, annular elevation and at least one outer circumferential, annular elevation to protrude from the surface of the conical sleeve by no more than 100 μm. Preferably, the at least one inner circumferential, annular elevation and at least one outer circumferential, annular elevation protrude from the surface of the conical sleeve by at least 30 μm and at most 50 μm.

The annular elevations of the conical sleeve and the at least one annular elevation of the electrically conductive metal pin can have a cross section in the shape of a segment. Owing to the arcuate (segment-like) shape, the contact force on the opposing faces is distributed evenly, which makes the sealing more secure. Furthermore, the segment-shaped design does not produce any sharp edges, which could locally cause high stresses or material damage.

Alternatively, the circumferential, annular elevations on the inside and outside of the conical sleeve can have a triangular cross section which forms the shape of a wedge.

According to a preferred embodiment, the conical sleeve has exactly three inner circumferential, annular elevations and exactly three outer circumferential, annular elevations. The three-fold arrangement results in a uniform and stable distribution of force and contact to secure the leak tightness.

Preferably, the outer circumferential, annular elevations of the conical sleeve are evenly spaced.

According to an advantageous embodiment, the inner circumferential, annular elevations and the outer circumferential, annular elevations are each arranged on the conical sleeve along a longitudinal axis of the conical sleeve such that they lie in one cross-sectional plane, i.e. are radially opposite. In this case, the deformation forces act in a radially cumulative manner, as a result of which the pressing effect of the conical sleeve in the conical housing opening and on the electrically conductive metal pin is locally increased. An axial offset of the inner circumferential, annular elevations and the outer circumferential, annular elevations should be avoided in order to minimise the risk of damaging shear forces within the conical sleeve.

For each of the above-described embodiments, it can be provided for the at least one inner circumferential, annular elevation and the at least one outer circumferential, annular elevation of the conical sleeve to be formed in a central portion along a longitudinal axis of the conical sleeve.

The invention also relates to a method for installing the electrical feedthrough in a corresponding conical housing opening of an electrical refrigerant compressor. The method is characterised in that the electrically conductive metal pin is inserted into the conical sleeve and axially pressed with the conical sleeve in the corresponding conical housing opening, wherein no additional joining or connecting agent is used between the inner wall of the conical housing opening and the conical sleeve or between the contacting surfaces of the electrically conductive metal pin and the conical sleeve. According to the method, the conical sleeve and the electrically conductive metal pin are pressed with one another in the conical housing opening such that the at least one inner circumferential, annular elevation and the at least one outer circumferential, annular elevation of the conical sleeve are pressed into the opposing metal surfaces, as a result of which a leak tightness which meets the requirements is achieved without an additional adhesive being necessary.

Furthermore, it can be provided according to the method for the axially pressed assembly of the conical sleeve and the electrically conductive metal pin not to be subjected to any additional heat treatment. It has been found that the necessary leak tightness and durability is also achieved without a heat treatment.

The installation of the electrical feedthrough according to the invention is thus carried out solely by axially pressing the electrically conductive metal pin with the conical sleeve in a conical housing opening. As a result, additional method steps, such as the introduction of adhesives and a subsequent heat treatment, are no longer necessary, which leads to savings in time and costs. With the electrical feedthroughs, the pressurised region is separated permanently and in a media-tight manner from the region exposed to atmospheric pressure, and at the same time a reliable transmission of electricity into the housing, specifically into the motor housing, is made possible.

### DESCRIPTION OF THE DRAWINGS

Further details, features and advantages of embodiments of the invention can be found in the description of exemplary embodiments below with reference to the associated drawings. In the drawings:

FIG. 1: shows a schematic diagram of electrical feedthroughs according to the prior art,

FIGS. 2A-2D: show schematic diagrams of an exemplary embodiment of a conical sleeve,

FIGS. 3A-3B: show schematic diagrams of an exemplary embodiment of an electrical feedthrough according to the invention,

FIG. 4: shows a schematic diagram of a detail of the conical sleeve, and

FIG. 5: shows schematic diagrams of an exemplary embodiment of an electrically conductive metal pin.

### DESCRIPTION OF AN EMBODIMENT

The term axial is used below to describe an orientation or an extension in the direction of a longitudinal axis or rotational axis. The term radial is used to describe something oriented outwards from the relevant axis.

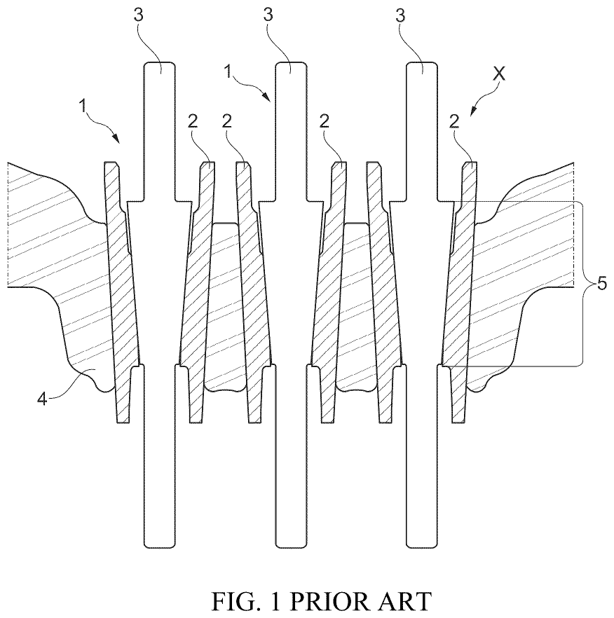

FIG. 1 shows a schematic diagram of electrical feedthroughs 1 in a variant known from the prior art. Each of the electrical feedthroughs 1 has an electrically insulating conical sleeve 2 and an electrically conductive metal pin 3. The conical sleeves 2 are characterised by their outer and inner conical shape. FIG. 1 shows the electrical feedthroughs 1 in the installed state in conical housing openings in a motor housing 4. The housing openings are conical bores which correspond with the outer shape of the conical sleeves 2. The electrically conductive metal pins 3 each have a conical portion 5 which corresponds with the conical inner shape of the conical sleeve 2. A contact face with the inside of the conical sleeve 2 is formed along the conical portion 5. According to the prior art, an epoxy adhesive is introduced in each case between the contact faces of the conical sleeves 2 and the motor housing 4 and between the contact faces of the conical sleeves 2 and the electrically conductive metal pins 3. To cure the epoxy adhesive, a time-consuming heat treatment can be provided, which is associated with additional costs.

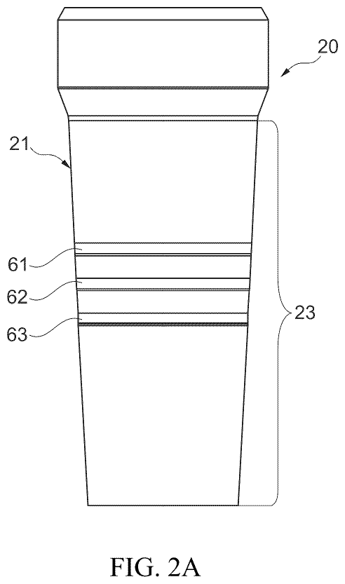

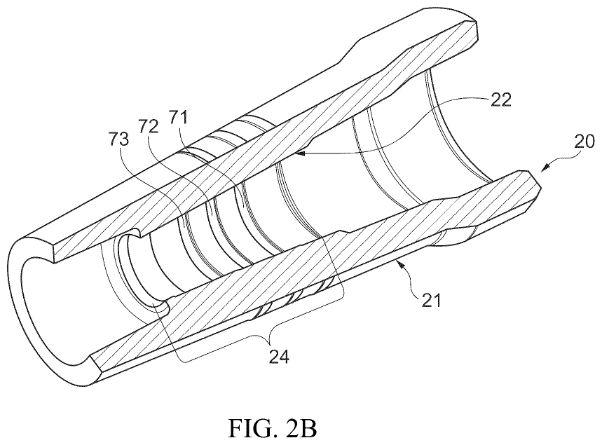

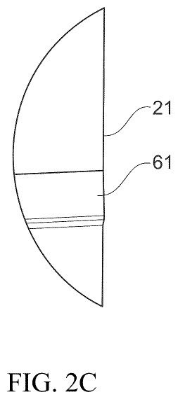

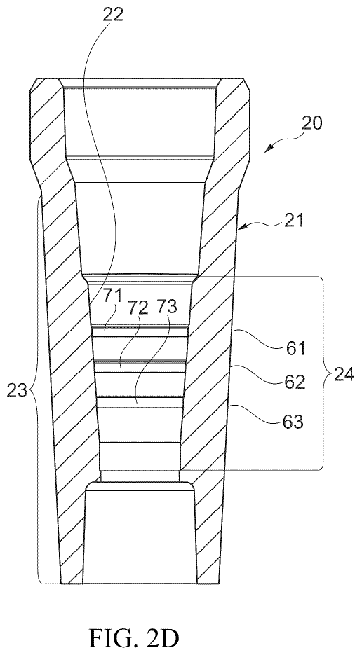

FIGS. 2A and 2B show schematic diagrams of an exemplary embodiment of a conical sleeve 20 according to the invention, wherein FIG. 2A shows an outer view of the conical sleeve 20, and wherein FIG. 2B shows a sectional diagram of the conical sleeve 20.

The conical sleeve 20 has a conically shaped outside 21, wherein three outer circumferential, annular elevations 61, 62, 63 in the form of sealing beads are formed in the central region along a longitudinal extent of the conical sleeve 20. In the example shown, the outer circumferential, annular elevations 61, 62, 63 each protrude by 50 μm from the conically shaped outside 21 of the conical sleeve 20. The arrangement of the outer circumferential, annular elevations 61, 62, 63 is selected such that the individual outer circumferential, annular elevations 61, 62, 63 are evenly spaced. The distance between two adjacent outer circumferential, annular elevations 61, 62, 63 is in each case greater than an axial extent, i.e., than a width of the outer circumferential, annular elevations 61, 62, 63.

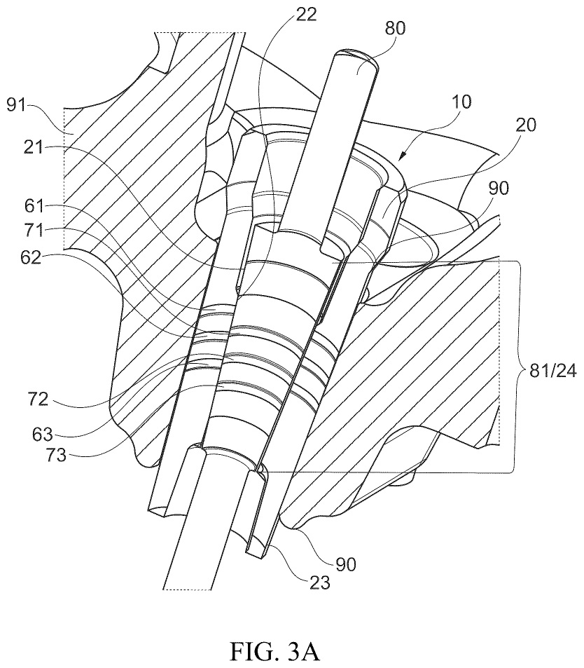

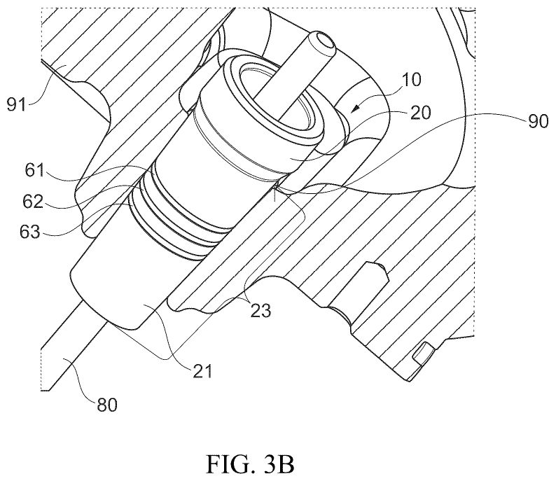

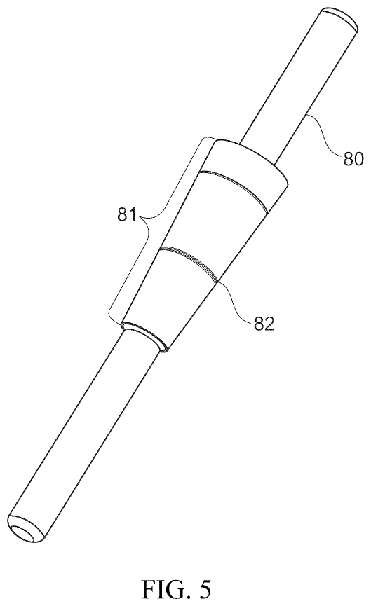

FIG. 2B shows a sectional diagram of the conical sleeve 20 shown in FIG. 2A, allowing a view into the interior of the conical sleeve 20. In the interior, the conical sleeve 20 has a conically shaped inside 22, which acts as a seat for an electrically conductive metal pin 80 (see FIG. 3A or 5). Owing to the conical shape, the conical sleeve 20 has axial openings of different sizes, wherein the larger opening is provided for introducing the electrically conductive metal pin 80 (not shown). The opening for introducing the electrically conductive metal pin 80 (not shown here) is slightly chamfered.

On the conically shaped inside 22 of the conical sleeve 20, three inner circumferential, annular elevations 71, 72, 73 are formed in a manner evenly spaced in the axial direction. The distance between two adjacent inner circumferential, annular elevations 71, 72, 73 is in each case greater than a width of the inner circumferential, annular elevations 71, 72, 73. The inner circumferential, annular elevations 71, 72, 73 are provided for sealing the electrically conductive metal pin 80 (see FIG. 3A or 5). In the example shown, the inner circumferential, annular elevations 71, 72, 73 each protrude by 50 μm from the conically shaped inside 22 of the conical sleeve 20.

In relation to the axial arrangement of the outer circumferential, annular elevations 61, 62, 63, the inner circumferential, annular elevations 71, 72, 73 lie in one cross-sectional plane with the outer circumferential, annular elevations 61, 62, 63 so that the outer circumferential, annular elevations 61, 62, 63 and the inner circumferential, annular elevations 71, 72, 73 are radially opposite one another.

The conical sleeve 20 has an outer cone 23 and an inner cone 24, wherein the inner cone 24 is designed to receive a conical portion 81 of the electrically conductive metal pin 80 (see FIG. 3A or 5). The angle of the inner cone 24 is steeper than the angle of the outer cone 23.

The outer circumferential, annular elevations 61, 62, 63 and the inner circumferential, annular elevations 71, 72, 73 each have a triangular cross section in the shape of a wedge.

The conical sleeve 20 is designed as a monolithic component consisting of a rock-meal-filled duromer cured by thermal crosslinking. The conical sleeve 20 is thus formed from a material which is harder than adjacent metal surfaces when the conical sleeve 20 is pressed with the electrically conductive metal pin 80 in a conical housing opening 90, as shown in FIGS. 3A-3B. Accordingly, in the pressed state (FIGS. 3A-3B), the metal surfaces of the conical housing opening 90 and the conical portion 81 of the electrically conductive metal pin 80 are deformed in the region of the outer circumferential, annular elevations 61, 62, 63 and the inner circumferential, annular elevations 71, 72, 73 which are formed on the surfaces of the conical sleeve 20, which contributes to an improved leak tightness.

FIG. 2C shows an enlarged diagram of the conical sleeve 20 with an outer circumferential, annular elevation 61 on the conical outside 21. The wedge shape of the outer circumferential, annular elevation 61 can be seen.

A further sectional diagram of the conical sleeve 20 is shown in FIG. 2D. FIG. 2D shows an axial longitudinal section through the conical sleeve 20 so that the outer circumferential, annular elevations 61, 62, 63 formed on the conically shaped outside 21 of the outer cone 23 and the inner circumferential, annular elevations 71, 72, 73 formed on the conically shaped inside 22 of the inner cone 24 can be seen. The outer circumferential, annular elevations 61, 62, 63 and the inner circumferential, annular elevations 71, 72, 73 are arranged radially opposite on the conical sleeve 20.

FIG. 3A shows a schematic diagram of an exemplary embodiment of an electrical feedthrough 10 according to the invention. The electrical feedthrough 10 is shown with the conical sleeve 20 and an electrically conductive metal pin 80 in the installed, pressed state in a conical housing opening 90 in a metal housing 91 of an electrical refrigerant compressor. The design of the conical housing 20 is shown transparently for better illustration and corresponds to the design shown in FIGS. 2A to 2D, in which outer circumferential, annular elevations 61, 62, 63 are formed on the conical outside 21. The electrical feedthrough 10 is provided for the electrical contacting of electrical loads encapsulated in the metal housing 91.

The electrically conductive metal pin 80 has a circular cylindrical main body, which has a conical portion 81 along its longitudinal axis. The conical portion 81 is contacted with the surface of the conical inside 22 of the conical sleeve 20 such that the conical portion 81 completely fills the inner cone 24. For better illustration, the conical portion 81 of the electrically conductive metal pin 80 is shown transparently so that the inner cone 24 with the inner circumferential, annular elevations 71, 72, 73 can be seen. In the installed state, the inner circumferential, annular elevations 71, 72, 73 press into the surface of the conical portion 81 of the electrically conductive metal pin 80. Owing to the contact force, the conical portion 81 of the electrically conductive metal pin 80 is locally slightly deformed in the region of the inner circumferential, annular elevations 71, 72, 73, as a result of which an improved leak tightness is produced between the conical sleeve 20 and the electrically conductive metal pin 80.

The inner and outer elevations 61, 62, 63, 71, 72, 73 are arranged on the conical sleeve 20 without an offset in the axial direction. Accordingly, the arrangement of the outer circumferential, annular elevations 61, 62, 63 and the inner circumferential, annular elevations 71, 72, 73 is such that the inner and outer elevations 61, 62, 63, 71, 72, 73 are radially opposite one another in each case. For example, the outer circumferential, annular elevation 61 and the inner circumferential, annular elevation 71 are radially opposite one another, and the outer circumferential, annular elevation 62 is radially opposite the inner circumferential, annular elevation 72, and so on.

In the example shown, the outer circumferential, annular elevations 61, 62, 63 press into the surface of the conical housing opening 90, as a result of which an improved leak tightness is produced between the conical sleeve 20 and the conical housing opening 90. Overall, the necessary leak tightness is achieved by the interaction of the electrically conductive metal pin 80 and the conical sleeve 20, in which the radial contact pressure of the radially opposing inner circumferential and outer circumferential, annular elevations 61, 62, 63, 71, 72, 73 on the contact faces is locally summed.

FIG. 3B shows the electrical feedthrough 10 with the conical sleeve 20 and the electrically conductive metal pin 80 in a conical housing opening 90 of the metal housing 91, which is shown in section. Owing to its axial length, the conical sleeve 20 protrudes by a portion of the outer cone 23 out of the conical housing opening 90. The outer circumferential, annular elevations 61, 62, 63 formed on the conically shaped outside 21 of the outer cone 23 are arranged such that, when in the pressed state, they are situated axially in the central portion of the conical housing opening 90 in relation to a wall thickness of the metal housing 91 at the conical housing opening 90.

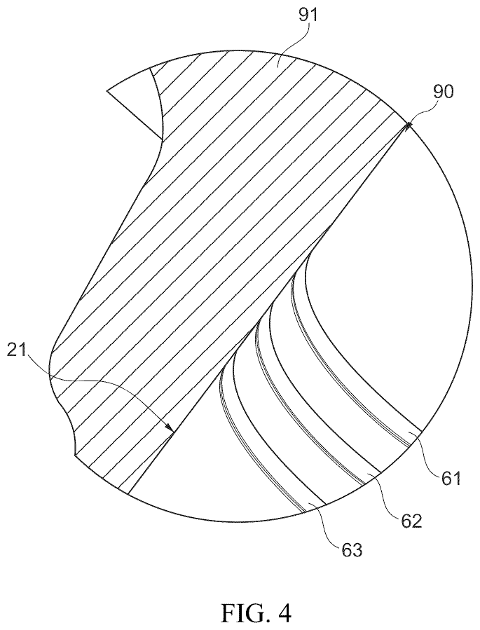

FIG. 4 shows a schematic diagram of a detail of the conical sleeve 20 in the installed state in the conical housing opening 90 of the metal housing 91. This is an enlarged diagram of the contact region between the surface of the conical housing opening 90 and the conical outside 21 on which the outer circumferential, annular elevations 61, 62, 63 are formed. As a result of the contact pressure, the outer circumferential, annular elevations 61, 62, 63 are pushed into the surface of the conical housing opening 90, whereby an additional sealing face with increased contact pressure is formed between the conical sleeve 20 and the conical housing opening 90.

FIG. 5 shows a schematic diagram of an exemplary embodiment of an electrically conductive metal pin 80. In the example shown, the electrically conductive metal pin 80 has an outer circumferential, annular elevation 82 in the conical portion 81. This elevation is formed from the material of the electrically conductive metal pin 80 and is consequently softer than the duromer material of the conical sleeve 20 (see, for example, FIGS. 2A to 2D). As a result, the outer circumferential, annular elevation 82 is deformed in the contact region on the conical inside 22 on introduction of the electrically conductive metal pin 80 into the conical sleeve 20, which results in an additional sealing effect.

The axial position of the outer circumferential, annular elevation 82 on the conical portion 81 is selected such that it lies in one plane with one of the annular elevations 61, 62, 63, 71, 72, 73 of the conical sleeve 20 in the axial direction when the electrically conductive metal pin 80 is in the installed state. The outer circumferential, annular elevation 82 preferably has the shape of a segment in cross section. Owing to the arcuate (segment-like) shape, the contact force on the opposing faces is distributed evenly, which makes the sealing more secure.

According to a further embodiment (not shown here), the electrically conductive metal pin 80 can have exactly three evenly spaced annular elevations 82 on the conical portion 81. These spaced annular elevations 82 are arranged such that they lie in one plane with the inner circumferential and outer circumferential, annular elevations 61, 62, 63, 71, 72, 73 of the conical sleeve 20 when in the installed state.

### LIST OF REFERENCE NUMERALS

1 Electrical feedthrough
2 Conical sleeve
3 Electrically conductive metal pin
4 Motor housing
5 Conical portion
10 Electrical feedthrough
20 Conical sleeve
21 Conical outside
22 Conical inside
23 Outer cone
24 Inner cone
61, 62, 63 Outer circumferential, annular elevation
71, 72, 73 Inner circumferential, annular elevation
80 Electrically conductive metal pin
81 Conical portion
82 Outer circumferential, annular elevation
90 Conical housing opening
91 Metal housing

What is claimed is:

1. An electrical feedthrough for encapsulated electrical components in an electrical refrigerant compressor of an air-conditioning system, the electrical feedthrough comprising:
a conical sleeve; and
an electrically conductive metal pin, the conical sleeve and the electrically conductive metal pin pressed into a corresponding conical housing opening in a metal housing, wherein the electrically conductive metal pin has a conical portion, which corresponds with an inner cone angle of the conical sleeve, wherein the conical sleeve is formed from a crosslinked thermosetting plastic and has at least one inner circumferential, annular elevation and at least one outer circumferential, annular elevation, which form an encircling, sealing press fit in the conical housing opening, wherein no additional joining or connecting agent is introduced between an inner wall of the conical housing opening and the conical sleeve or between contacting surfaces of the electrically conductive metal pin and the conical sleeve.

2. The electrical feedthrough according to claim 1, wherein the crosslinked thermosetting plastic from which the conical sleeve is formed is a rock-meal-filled, phenol-resin-based resin.

3. The electrical feedthrough according to claim 1, wherein the inner cone angle of the conical sleeve is steeper than an outer cone angle of the conical sleeve.

4. The electrical feedthrough according to claim 1, wherein the at least one inner circumferential, annular elevation and the at least one outer circumferential, annular elevation protrude from a surface of the conical sleeve by no more than 100 μm.

5. The electrical feedthrough according to claim 1, wherein the electrically conductive metal pin is formed from metal and has at least one outer circumferential, annular elevation along the conical portion of the electrically conductive metal pin.

6. The electrical feedthrough according to claim 5, wherein the at least one outer circumferential, annular elevation and the at least one inner circumferential, annular elevation of the conical sleeve and the at least one annular elevation of the electrically conductive metal pin have a cross section in a shape of a segment.

7. The electrical feedthrough according to claim 1, wherein the at least one outer circumferential, annular elevation and the at least one inner circumferential, annular elevation of the conical sleeve have a triangular cross section which forms a shape of a wedge.

8. The electrical feedthrough according to claim 1, wherein the conical sleeve has exactly three inner circumferential, annular elevations and exactly three outer circumferential, annular elevations.

9. The electrical feedthrough according to claim 8, wherein the inner circumferential, annular elevations and the outer circumferential, annular elevations of the conical sleeve are evenly spaced.

10. The electrical feedthrough according to claim 8, wherein the inner circumferential, annular elevations and the outer circumferential, annular elevations of the conical sleeve are arranged in a radially superimposed manner along a longitudinal axis of the conical sleeve.

11. The electrical feedthrough according to claim 1, wherein the at least one inner circumferential, annular elevation and the at least one outer circumferential, annular elevation of the conical sleeve are formed in a central portion along a longitudinal axis of the conical sleeve.

12. A method for installing the electrical feedthrough according to claim 1 in the corresponding conical housing opening of the electrical refrigerant compressor, wherein the electrically conductive metal pin is inserted into the conical sleeve and is pressed, together with the conical sleeve, into the corresponding conical housing opening by application of an axial pressure force, wherein no additional joining or connecting agent is used between the inner wall of the conical housing opening and the conical sleeve or between the contacting surfaces of the electrically conductive metal pin and the conical sleeve.

13. The method according to claim 12, wherein an axially pressed assembly consisting of the conical sleeve and the electrically conductive metal pin is not subjected to any additional heat treatment.

14. The electrical feedthrough according to claim 2, wherein the crosslinked thermosetting plastic from which the conical sleeve is formed is a phenol formaldehyde resin, which is cured by thermal crosslinking.
